(19) United States
(12) Patent Application Publication
(10) Pub. No.: US 2007/0081134 A1
(43) Pub. Date: Apr. 12, 2007

(54) EXPOSURE APPARATUS AND DEVICE MANUFACTURING METHOD USING THE SAME

(75) Inventor: Toshitaka AMANO, Kawachi-gun (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/539,281

(22) Filed: Oct. 6, 2006

(30) Foreign Application Priority Data
Oct. 7, 2005 (JP) 2005-295557

(51) Int. Cl. G03B 27/42

(52) U.S. Cl. 355/53; 355/55

(57) ABSTRACT

This invention relates to an exposure apparatus for exposing a substrate to a pattern. The exposure apparatus includes a unit, and a controller configured to determine, based on a state quantity of the unit upon executing one of calibration of the unit and measurement by the unit and a current state quantity of the unit, whether one of the calibration and the measurement is valid, and to control, upon determining that one of the calibration and the measurement is invalid, an operation of the exposure apparatus so that the one of the calibration and the measurement is re-executed.

### BACKGROUND OF THE INVENTION

1. Field of the Invention

The present invention relates to an exposure apparatus, a method applied to an exposure apparatus, and a device manufacturing method using the exposure apparatus.

2. Description of the Related Art

A semiconductor exposure apparatus executes calibration/measurement such as base line correction and auto-focus correction before an exposure process or executes alignment measurement in an overlay process to maximize the exposure performance. Once correction measurement is normally completed, the conventional semiconductor exposure apparatus calculates correction values based on the normally obtained measurement values and reflects them on the exposure process (Japanese Patent No. 3218631).

However, the correction values obtained by conventional calibration/measurement or alignment measurement are values under an apparatus environment at the time of measurement. If the apparatus environment changes then, offsets are generated in the correction values during the time from the measurement to the exposure process using the reflected correction value.

The recent microdevice manufacturing process requires accurate correction in an accurately maintained apparatus state. There are currently several hundred correction parameters. The tendency is to maintain the apparatus accuracy by further increasing the kinds of correction parameters. Variations allowable in individual correction values are also becoming stricter. Under these circumstances, the increase in the kinds of correction parameters makes the measurement/correction time longer. It is necessary to repeat correction in a short time if the variation allowance becomes stricter. The important challenge for the exposure apparatus is to improve the productivity.

### SUMMARY OF THE INVENTION

The present invention has been made in consideration of the above background, and has as its exemplary object to improve the utilization efficiency of an exposure apparatus.

According to a first aspect of the present invention, there is provided an exposure apparatus for exposing a substrate to a pattern, the apparatus comprising a unit, and a controller configured to determine, based on a state quantity of the unit upon executing one of calibration of the unit and measurement by the unit and a current state quantity of the unit, whether one of the calibration and the measurement is valid, and to control, upon determining that one of the calibration and the measurement is invalid, an operation of the exposure apparatus so that the one of the calibration and the measurement is re-executed.

According to a second aspect of the present invention, there is provided a method applied to an exposure apparatus for exposing a substrate to a pattern, the method comprising steps of determining, based on a state quantity of a unit upon executing one of calibration of the unit and measurement by the unit and a current state quantity of the unit, whether one of the calibration and the measurement is valid, and controlling, if it is determined that one of the calibration and the measurement is invalid, an operation of the exposure apparatus so that the one of the calibration and the measurement is re-executed.

Further features of the present invention will become apparent from the following description of exemplary embodiments with reference to the attached drawings.

### BRIEF DESCRIPTION OF THE DRAWINGS

FIG. 1 is a schematic view of an exposure apparatus;

FIG. 2 is a chart showing the sequence of an exposure process;

FIG. 3 is a graph showing a lens power variation with respect to the lens temperature of a projection optical system;

FIG. 4 is a chart showing the sequence of an exposure process according to the first embodiment;

FIG. 5 is a graph showing the lens temperature of a projection optical system in correction value determination according to the first embodiment;

FIG. 6 is a chart showing the sequence of an exposure process according to the second embodiment;

FIG. 7 is a chart showing the sequence of an exposure process according to the third embodiment;

FIGS. 8A to 8C are graphs showing the reticle stage position and the base line variation;

FIGS. 9A to 9C are graphs showing the wafer stage position and the base line variation;

FIG. 10 is a graph showing the wafer stage position (under Off-Axis) and the base line variation;

FIG. 11 is a chart showing the sequence of an exposure process according to the fourth embodiment; and

FIG. 12 is a flowchart showing the entire semiconductor device manufacturing process.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

The embodiments are applicable to a projecting exposure apparatus for manufacturing a semiconductor circuit element such as an IC, LSI, or VLSI, a device manufacturing method and semiconductor manufacturing factory using the same, and an exposure apparatus operation method.

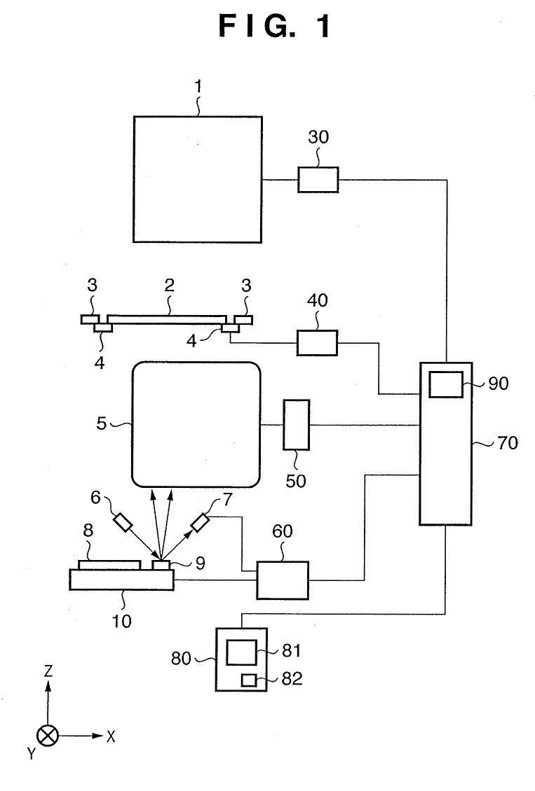

FIG. 1 is a schematic view of an exposure apparatus according to an embodiment. Referring to FIG. 1, an illumination optical system for changing the shape of illumination light emitted from a light source 1 is formed between the light source 1 and a reticle stage 4. A gas such as N2 purges the interior of the illumination optical system for the purpose of, e.g., stabilizing the imaging performance. A flowmeter arranged near the spray nozzle or exhaust nozzle of the gas (not shown) can measure the flow rate of the purge gas. In transferring a pattern formed on a reticle 2 to a wafer 8, a light source control system 30 receives an instruction from an exposure apparatus controller 70 and outputs an instruction to control the operation of the light source 1. The illumination optical system incorporates a barometer to measure the atmospheric pressure value and a thermometer to measure the temperature of the atmosphere in the illumination optical system. The illumination optical system also incorporates thermometers to measure the temperature of the atmosphere in the illumination optical system and the temperature of the atmosphere between the illumination optical system and the reticle stage 4.

The reticle stage 4 holds the reticle 2. The reticle stage 4 also holds a reticle reference plate 3 having a plurality of kinds of reference marks (not shown). The reticle reference plate 3 may be fixed to a position that is optically equivalent to the reticle. In a scanning exposure apparatus, the reticle stage 4 can move in the optical axis direction (Z-axis direction) of a projection optical system 5 and in directions (X- and Y-axis directions) perpendicular to the optical axis direction. The reticle stage 4 can also rotate with respect to the optical axis.

The exposure apparatus controller 70 outputs an instruction to a reticle stage control system 40. The reticle stage control system 40 controls drive of the reticle stage 4 by issuing an instruction. A position detection system (not shown) such as a laser interferometer or encoder measures the position of the reticle stage 4. To prevent heat generation in the reticle stage 4, a liquid such as pure water may circulate through it, or a gas may directly blow against it. In this case, the reticle stage 4 can have a flowmeter to measure the flow rate of the liquid or gas and a thermometer to measure the temperature.

The projection optical system 5 includes a plurality of lenses. At the time of exposure, the pattern formed on the reticle 2 forms an image on the wafer 8 at a magnification corresponding to the reduction magnification of the projection optical system 5. In the projection optical system 5, a position detection system (not shown) such as a laser interferometer or encoder measures the position of each lens. The projection optical system 5 comprises a thermometer to measure the temperature of the atmosphere in the projection optical system 5 and a barometer to measure the atmospheric pressure. To dissipate heat absorbed by the lenses, a liquid such as pure water may circulate through the projection optical system 5, or a gas may directly blow against it. In this case, the projection optical system 5 can have a flowmeter to measure the flow rate of the liquid or gas and a flowmeter to measure the flow rate of a purge gas such as N₂ for the purpose of, e.g., stabilizing the imaging performance.

The illumination optical system and the reticle stage 4 have therebetween a TTR (Through The Reticle) observation optical system of TTR scheme capable of simultaneously observing and measuring structures from the reticle to the wafer through the projection optical system. The TTR observation optical system comprises an objective lens to change the observation point and a relay lens to change the focal point of an observation target object.

The TTR observation optical system comprises a thermometer to measure the temperature of the atmosphere and a barometer to measure the atmospheric pressure. To dissipate heat absorbed by the objective lens and relay lens, a liquid such as pure water may circulate through the TTR observation optical system, or a gas may directly blow against it. At this time, the TTR observation optical system includes a flowmeter to measure the flow rate of the liquid or gas, a flowmeter to measure the flow rate of a purge gas such as N₂ for the purpose of, e.g., stabilizing the imaging performance, and a position detection system such as a laser interferometer or encoder to measure the positions of the objective lens and relay lens.

A light projection optical system 6 and a detection optical system 7 form an off-axis auto-focus optical system. A light beam serving as non-exposure light emitted from the light projection optical system 6 focuses on a point on a stage reference plate 9 (or the upper surface of the wafer 8) and reflects. The reflected light beam enters the detection optical system 7. The detection optical system 7 incorporates a position detection light-receiving element (not shown). The position detection light-receiving element and the light reflecting point on the stage reference plate 9 are conjugate with each other. The positional shift of the stage reference plate 9 in the optical axis direction of the projection optical system 5 is measured as the positional shift of the incident light beam on the position detection light-receiving element in the detection optical system 7. A wafer stage control system 60 receives the positional shift of the stage reference plate 9 from a predetermined reference surface measured by the detection optical system 7.

In focus calibration/measurement (to be described later), the wafer stage control system 60 vertically drives the stage reference plate 9 in the optical axis direction (Z-axis direction) of the projection optical system 5 near a predetermined reference position. In exposure, the wafer stage control system 60 also controls the position of the wafer 8.

The apparatus also includes an Off-Axis observation optical system (not shown) of Off-Axis scheme capable of observing and measuring the surface of the wafer 8 by non-exposure light. The Off-Axis observation optical system includes a thermometer to measure the temperature of the atmosphere and a barometer to measure the atmospheric pressure.

A console 80 serves as an operation unit, for an operator, using a workstation or personal computer. The console 80 comprises a display unit 81 and a storage device 82.

The exposure apparatus controller 70 has a time measuring function of measuring the stay time at the current position based on position information from a unit control system. The exposure apparatus controller 70 also includes a determination unit 90 which determines the validity of one of calibration of the units included in the exposure apparatus and measurement by the units. The determination unit 90 determines whether to re-execute one of the calibration and measurement and whether to recalculate correction values based on the calibration or measurement and executes recalculation. The exposure apparatus controller 70 corrects and controls the units included in the exposure apparatus based on the correction values to maintain an optimum and accurate apparatus state.

### First Embodiment

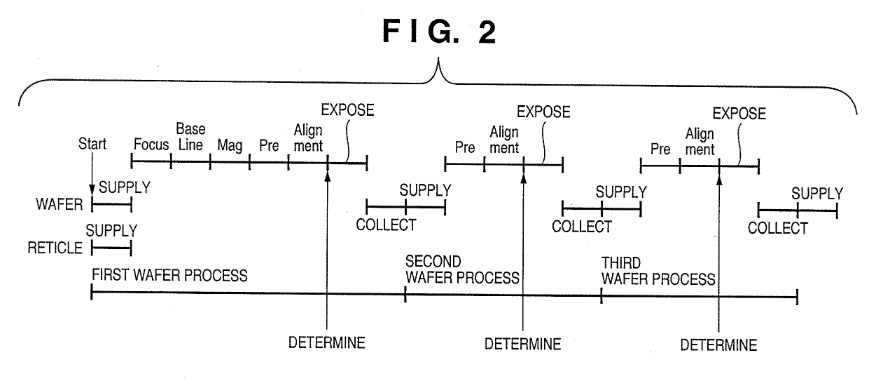

In a preferred first embodiment of the present invention, a method of executing an exposure process based on one of calibration of the units included in an exposure apparatus and measurement by the units will be described. FIG. 2 is a chart showing the sequence of an exposure process. Simultaneously with Start of the exposure process, a reticle 2 and wafer 8 to be used in the exposure process are supplied into the exposure apparatus. When supply of the reticle 2 and wafer 8 is complete, the apparatus executes one of calibration of the units included in the exposure apparatus and measurement by the units. An exposure apparatus controller 70 calculates and sets the correction values or offset values of the units based on the result of calibration or measurement. The correction values include, e.g., a value to calibrate measurement values by the units, the values of operation parameters of the units, the value of driving parameters in driving the units, and the values of control parameters in controlling the units (ditto with the following).

Referring to FIG. 2, the apparatus executes correction/measurement to accurately overlay a pattern formed on the reticle 2 on the wafer 8 and transfer the pattern and calculates correction values in accordance with the sequence of focus measurement (Focus), base line measurement (Base Line), lens power measurement (Mag), pre-alignment measurement (Pre), and alignment measurement (Alignment). A memory (e.g., storage device 82) stores the unit state quantities (e.g., the temperature of a unit used in measurement, the internal and ambient atmospheric pressures of a unit used in measurement, and the flow rate of a liquid or gas (refrigerant) used in a unit used in measurement) during correction/measurement together with the correction values obtained by correction/measurement.

A determination unit 90 determines the validity of each correction value immediately before the exposure process. The correction values include not only the focus, base line, lens power, and alignment but also arbitrary correction values (e.g., scan shifts in scan-driving a reticle stage 4 and a wafer stage and quadrature shifts of the reticle stage 4 and wafer stage from ideal grids) to guarantee the performance of the exposure apparatus and arbitrary correction values (e.g., the magnification and deflection of the reticle 2 and the surface shape of the wafer 8) to accurately execute the exposure process. If the determination unit 90 determines that the correction values are valid, the exposure apparatus controller 70 executes the exposure process by correcting and driving the units by using the correction values.

Referring to FIG. 2, the focus, base line, lens power, and alignment measurements before the exposure process of the first wafer are normally complete. In addition, the determination unit 90 determines by correction value determination immediately before the exposure process for each wafer that the correction values are valid. For these reasons, the apparatus executes the exposure process of the first wafer by reflecting the correction values obtained by the correction value measurement immediately before, the correction values for the accurate exposure process, and the correction values to guarantee the exposure apparatus performance.

To improve throughput, the process of the second and third wafers is done without correction/measurement of the focus, base line, and lens power. In processing the second and third wafers, the focus, base line, and lens power correction value determination immediately before the exposure process is done by comparing the unit state quantities (e.g., the temperature of a unit, the internal and ambient atmospheric pressures of a unit, and the flow rate of a liquid or gas used in a unit) in correction/measurement before the exposure process of the first wafer with the current unit state quantities. The correction values to guarantee the exposure apparatus performance and the correction values for the accurate exposure process are also determined by comparing the unit state quantities in correction/measurement with the current unit state quantities. Let xᵢ be a unit state quantity in correction/measurement, and yᵢ be a current unit state quantity corresponding to xᵢ. The determination unit 90 can determine the validity of each correction value in accordance with

$$\{ \begin{matrix}0 \vert {x}_{i} - {y}_{i} \vert > {δ}_{i} \\ 1 \vert {x}_{i} - {y}_{i} \vert \leq {δ}_{i}\end{matrix} \qquad ( 1 )$$

More specifically, when the absolute difference value between the unit state quantity xᵢ in correction/measurement and the current unit state quantity yᵢ exceeds a threshold value δᵢ, the determination unit 90 determines 0 (invalid). When the absolute difference value between the unit state quantity xᵢ in correction/measurement and the current unit state quantity yᵢ is equal to or smaller than the threshold value δᵢ, the determination unit 90 determines 1 (valid). If there are a plurality of unit state quantities, determination based on inequalities (1) is done for each state quantity. The unit state quantity xᵢ in correction/measurement is not particularly limited. Typical examples are (1) the temperature (x₁) of a unit used in correction/measurement, (2) the internal or ambient atmospheric pressure (x₂) of a unit used in correction/measurement, and (3) the flow rate (x₃) of a liquid or gas used in a unit used in correction/measurement. Examples of the current unit state quantity yᵢ corresponding to them are (1) the current temperature (y₁) of each unit, (2) the current internal or ambient atmospheric pressure (y₂) of each unit, and (3) the current flow rate (y₃) of a liquid or gas used in each unit. The method of determining the validity of each correction value is not limited to the above-described method. Various modifications are available, including a method of, e.g., determining whether a sum Σ|xᵢ−yᵢ| of the absolute difference values of the plurality of unit state quantities exceeds a threshold value δ. The technical scope of the present invention also incorporates these modifications.

As described above, when the comparison result exceeds the threshold value, the determination unit 90 determines that the correction value is not valid so that the apparatus automatically re-measures the correction values. It is also possible to omit determination of the correction values to guarantee the exposure apparatus performance, the correction values necessary for the accurate exposure process, and the correction values such as the focus correction value, base line correction value, and lens power correction value in consideration of the actual variations of unit state quantities (measurement conditions), the actual variations of correction values, and the actual correction residuals as an exposure result. In this case, the apparatus measures the state quantity of only a specific unit with a large variation and automatically executes re-measurement based on predicted variations of related correction values when the unit state quantity has varied. Execution of a minimum necessary re-measurement process improves the apparatus operation efficiency.

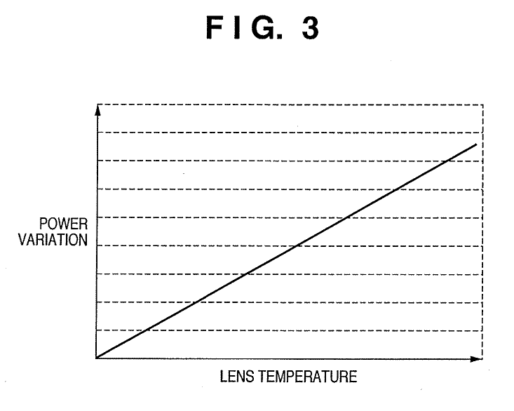

A detailed example will be described below. FIG. 3 is a graph showing the relationship between a lens power variation obtained from a lens power measurement result and the lens temperature of the projection optical system in measuring the lens power.

The ordinate of FIG. 3 represents the variation in lens power correction value (magnification variation), and the abscissa represents the lens temperature of the projection optical system. As shown in FIG. 3, the variation in lens power correction value linearly changes with respect to the lens temperature of the projection optical system. FIG. 3 illustrates only the relationship between the lens power correction value and the lens temperature of the projection optical system. The memory (e.g., storage device 82) in the apparatus may store the relationships between the correction values and the temperatures, atmospheric pressures, and flow rates of arbitrary units used in correction/measurement, e.g., the relationships between the focus correction value and the reticle stage temperature, between the focus correction value and the wafer stage temperature, and between a scan shift correction value in scan-driving the reticle stage 4 and the reticle stage temperature. If the exposure apparatus connects to an external device such as a host computer by online, the external device may store them.

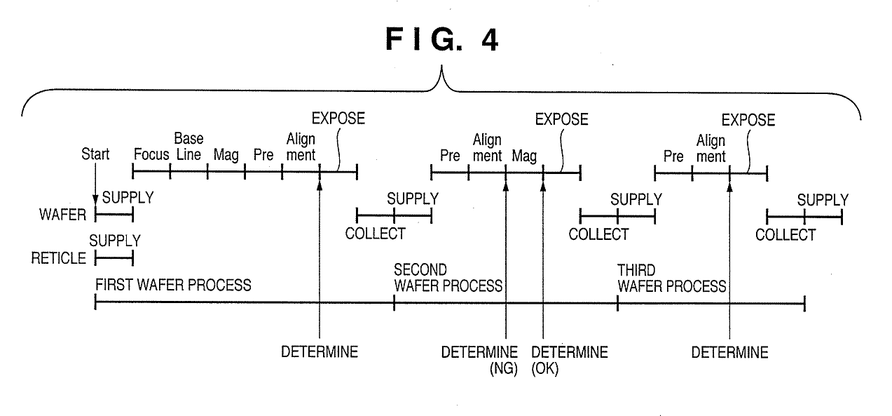

FIG. 4 is a chart showing the sequence of an exposure process in which the determination unit 90 determines by correction value determination that the lens power correction value is invalid in the second wafer process of the exposure process sequence shown in FIG. 2 so that the apparatus automatically executes re-measurement.

Referring to FIG. 4, the focus, base line, lens power, and alignment measurements before the exposure process of the first wafer are normally complete. In addition, the determination unit 90 determines by correction value determination immediately before the exposure process for each wafer that the correction values are valid. For these reasons, the apparatus executes the exposure process of the first wafer by reflecting the correction values obtained by the correction value measurement immediately before, the correction values to guarantee the exposure apparatus performance, and the correction values for the accurate exposure process.

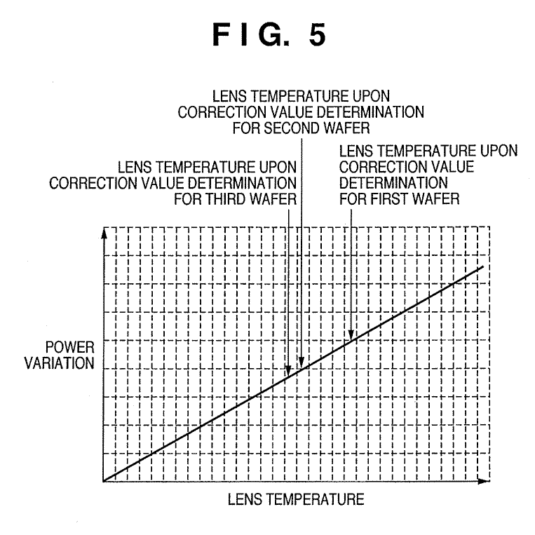

In correction value determination before the exposure process of the second wafer, the lens temperature of the projection optical system changes, as shown in FIG. 5. One scale of the abscissa corresponds to 0.02° C., and one scale of the ordinate corresponds to 5 ppm. The lens temperature of the projection optical system at the current time (in correction value determination for the second wafer) changes by about 0.08° C. from the lens temperature of the projection optical system in lens power correction/measurement for the first wafer. When the threshold value of allowance of a change in lens temperature of the projection optical system is 0.05° C., the determination unit 90 determines that “the lens power correction value is invalid.”

Assume that the correction values (e.g., the focus correction value and the quadrature shifts of the reticle stage 4 and wafer stage from ideal grids) except the lens power correction value with respect to the change in lens temperature of the projection optical system are valid. In this case, the lens power correction value is re-measured immediately before the exposure process of the second wafer.

In this embodiment, the threshold value is set for a temperature variation of 0.05° C. The exposure apparatus may set the threshold value in advance. Alternatively, the memory (e.g., storage device 82) of the exposure apparatus may store the relationship between a unit state quantity and a correction value in the past, and the exposure apparatus controller 70 may automatically set the threshold value based on the relationship between a variation in unit state quantity and a variation in correction value. A host computer or the like may set the threshold value.

It is preferable to prepare a “threshold value for a temperature change”, “threshold value for an atmospheric pressure change”, and “threshold value for a flow rate change” of a specific correction value of each unit. The validity of a correction value can be determined by employing the “most strict one” or “most lenient one” of the plurality of threshold values, or a “threshold value considering the process allowance.”

Since the allowable correction error changes depending on the process, a correction error may be set as a process parameter in advance. The host computer may set the process allowance. In this case, the exposure apparatus controller 70 decides the threshold value by determining the allowable range of correction error based on the process allowance. The correction value validity determination of this embodiment is done immediately before the wafer process. The validity of each correction value may be determined between shot exposure processes (between the end of one shot exposure and the next shot exposure).

Lens power correction measurement has been described in this embodiment. In, e.g., base line measurement, the correction value may be re-measured in the following way. Base line measurement uses the TTR observation optical system and Off-Axis observation optical system. In this case, the apparatus determines validity of the current state quantity of the TTR observation optical system and the current state quantity of the Off-Axis observation optical system. Re-measurement may be executed for only a unit whose state quantity is determined to be invalid. The same processing is possible even for other measurements using a plurality of units.

### Second Embodiment

In a preferred second embodiment of the present invention, a control method of automatically recalculating correction values will be described. FIG. 2 is a chart showing the sequence of an exposure process. The description of the sequence of the exposure process has been done above in the first embodiment and will be omitted here.

A memory (e.g., storage device 82) stores unit state quantities (e.g., the temperature of a unit used in measurement, the internal and ambient atmospheric pressures of a unit used in measurement, and the flow rate of a liquid or gas used in a unit used in measurement) during correction/measurement together the correction values.

A determination unit 90 determines the validity of each correction value immediately before the exposure process. The correction values include not only the focus, base line, lens power, and alignment but also arbitrary correction values (e.g., scan shifts in scan-driving a reticle stage 4 and a wafer stage and quadrature shifts of the reticle stage 4 and wafer stage from ideal grids) to guarantee the performance of the exposure apparatus and arbitrary correction values (e.g., the magnification and deflection of a reticle 2 and the surface shape of a wafer 8) to accurately execute the exposure process. If the determination unit 90 determines that the correction values are valid, an exposure apparatus controller 70 executes the exposure process by correcting and driving the units by using the correction values. The criterion of the validity of each correction value and the determination method are the same as in the first embodiment, and a description thereof will be omitted.

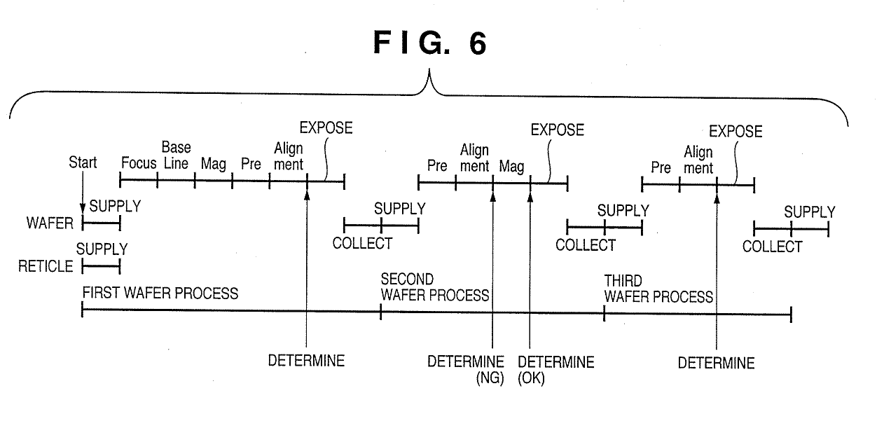

FIG. 6 is a chart showing the sequence of an exposure process in which the determination unit 90 determines by correction value determination that the lens power correction value is invalid (NG) in the second wafer process of the exposure process sequence shown in FIG. 2 so that the apparatus automatically recalculates the correction value.

Referring to FIG. 6, the focus, base line, lens power, and alignment measurements before the exposure process of the first wafer are normally complete. In addition, the determination unit 90 determines by correction value determination immediately before the exposure process for each wafer that the correction values are valid. For these reasons, the apparatus executes the exposure process of the first wafer by reflecting the correction values obtained by the correction value measurement immediately before, the correction values to guarantee the exposure apparatus performance, and the correction values for the accurate exposure process.

In correction value determination before the exposure process of the second wafer, the lens temperature of the projection optical system changes, as shown in FIG. 5. One scale of the abscissa corresponds to 0.02° C., and one scale of the ordinate corresponds to 5 ppm. The lens temperature of the projection optical system at the current time (in correction value determination for the second wafer) changes by about 0.08° C. from the lens temperature of the projection optical system in lens power correction/measurement for the first wafer. When the threshold value of allowance of a change in lens temperature of the projection optical system is 0.05° C., the determination unit 90 determines that “the lens power correction value is invalid.”

Assume that the correction values (e.g., the focus correction value and the quadrature shifts of the reticle stage 4 and wafer stage from ideal grids) except the lens power correction value with respect to the change in lens temperature of the projection optical system are valid.

As is apparent from FIG. 5, when the lens temperature of the projection optical system changes in the (−) direction, the lens power correction value also changes in the (−) direction. Hence, in the exposure process of the second wafer, the exposure apparatus controller 70 recalculates the correction value by adding −5 ppm, i.e., the lens power correction value variation when the lens temperature of the projection optical system changes by 0.08° C. to the current lens power correction value.

When the current lens power correction value is 5 ppm, the lens power correction value is recalculated as current lens power correction value (5 ppm)+correction amount (−5 ppm)=0 ppm. The lens power correction value to be reflected in the exposure process of the second wafer is 0 ppm.

As the correction value recalculation method, the apparatus may express the relationship between a correction value and a unit state quantity variation as a formula in advance and recalculate the correction value by substituting the unit state quantity variation to the formula.

In this embodiment, the relational expression between a current lens power correction value (β_{old}), a recalculated lens power correction value (β_{new}), a lens temperature (T_{olc}) of the projection optical system in measuring the current lens power correction value, and a current lens temperature (T_{now}) of the projection optical system is given by
β_{new}=β_{old}+((T_{now}−T_{old})×a+b) (2)
where a and b are the tilt (a) and intercept (b) of the line obtained from the graph in FIG. 5. As is apparent from FIG. 5, a=62.5, and b=0, equation (2) is rewritten to β_{new}=5+(−0.08×62.5+0)=0 [ppm].

In this embodiment, the lens power correction value is recalculated based on the relational expression between the lens power correction value and the lens temperature of the projection optical system. However, obtaining the relational expression between a correction value and a unit state quantity in advance based on a theoretical value or an actual value on the apparatus makes it possible to recalculate each correction value based on a unit state quantity. In this embodiment, the relational expression between the lens power correction value and the lens temperature of the projection optical system has been described. However, the correction value does not always vary in accordance with a change in only one unit state quantity.

Hence, the relational expression preferably contains changes in a plurality of unit state quantities. For accurate correction value recalculation, the relational expression of the lens power correction value preferably reflects factors such as the above-described projection optical system lens temperature, TTR observation optical system atmosphere temperature, projection optical system lens atmospheric pressure, and wafer stage temperature that cause a variation in the correction value.

In this embodiment, the threshold value is set for a temperature variation of 0.05° C. The exposure apparatus may set the threshold value in advance. Alternatively, the memory (e.g., storage device 82) of the exposure apparatus may store the relationship between a unit state quantity and a correction value in the past, and the exposure apparatus controller 70 may automatically set the threshold value based on the relationship between a variation and a variation in correction value. A host computer or the like may set the threshold value.

It is preferable to prepare a “threshold value for a temperature change”, “threshold value for an atmospheric pressure change”, and “threshold value for a flow rate change” of a specific correction value of each unit. The validity of a correction value can be determined by employing the “most strict one” or “most lenient one” of the plurality of threshold values, or a “threshold value considering the process allowance.”

Since the allowable correction error changes depending on the process, a correction error may be set as a process parameter in advance. The host computer may set the process allowance. In this case, the exposure apparatus controller 70 decides the threshold value by determining the allowable range of correction error based on the process allowance.

The correction value validity determination of this embodiment is done immediately before the wafer process. The validity of each correction value may be determined between shot exposure processes (between the end of one shot exposure and the next shot exposure).

Lens power correction recalculation has been described in this embodiment. In, e.g., base line measurement, the correction value may be recalculated in the following way. Base line measurement uses the TTR observation optical system and Off-Axis observation optical system. In this case, the apparatus determines validity of the current state quantity of the TTR observation optical system and the current state quantity of the Off-Axis observation optical system. Recalculation may be executed for only a unit whose state quantity is determined to be invalid. The same processing is possible even for other measurements using a plurality of units.

### Third Embodiment

In a preferred third embodiment of the present invention, a control method of automatically re-measuring correction values after the apparatus stops for a predetermined time will be described. FIG. 2 is a chart showing the sequence of an exposure process. The description of the sequence of the exposure process has been done above and will be omitted here.

A memory (e.g., storage device 82) stores unit state quantities (e.g., the temperature of a unit used in measurement, the internal and ambient atmospheric pressures of a unit used in measurement, and the flow rate of a liquid or gas used in a unit used in measurement) during correction/measurement together the correction values.

A determination unit 90 determines the validity of each correction value immediately before the exposure process. The correction values include not only the focus, base line, lens power, and alignment but also correction values (e.g., scan shifts in scan-driving a reticle stage 4 and a wafer stage and quadrature shifts of the reticle stage 4 and wafer stage from ideal grids) to guarantee the performance of the exposure apparatus and correction values (e.g., the magnification and deflection of a reticle 2 and the surface shape of a wafer 8) to accurately execute the exposure process. If the determination unit 90 determines that the correction values are valid, an exposure apparatus controller 70 executes the exposure process by correcting and driving the units by using the correction values. The criterion of the validity of each correction value and the determination method are the same as in the first embodiment, and a detailed description thereof will be omitted.

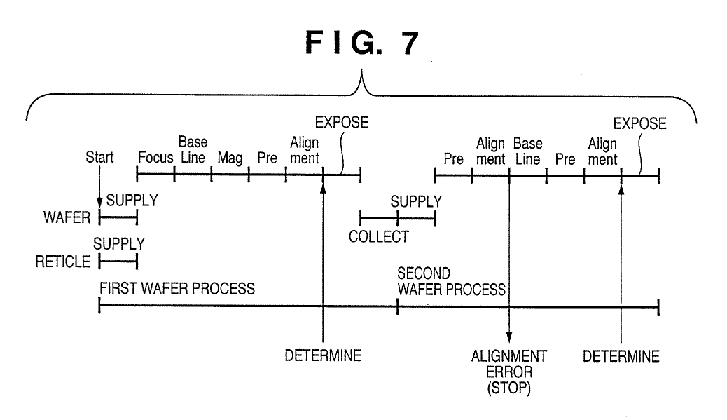

FIG. 7 is a chart showing the sequence of an exposure process in which a measurement error occurs during alignment measurement in the second wafer process of the exposure process sequence shown in FIG. 2, and the determination unit 90 executes correction value determination after the error stop of the apparatus and determines that the base line correction value is invalid so that the apparatus automatically executes base line measurement, pre-alignment, and alignment measurement.

Referring to FIG. 7, the focus, base line, lens power, and alignment measurements before the exposure process of the first wafer are normally complete. In addition, the determination unit 90 determines by correction value determination immediately before the exposure process for each wafer that the correction values are valid. For these reasons, the apparatus executes the exposure process of the first wafer by reflecting the correction values obtained by the correction value measurement immediately before, the correction values to guarantee the exposure apparatus performance, and the correction values for the accurate exposure process.

Assume that a measurement error has occurred during alignment measurement of the second wafer, and the apparatus has stopped by the error. As the positions of the target units (reticle stage 4 and wafer stage) of this example, the reticle stage 4 rests at the center of the apparatus, and the wafer stage rests under the Off-Axis observation optical system when the apparatus stops. With the stop of the apparatus, a timer function starts measuring the apparatus stop time.

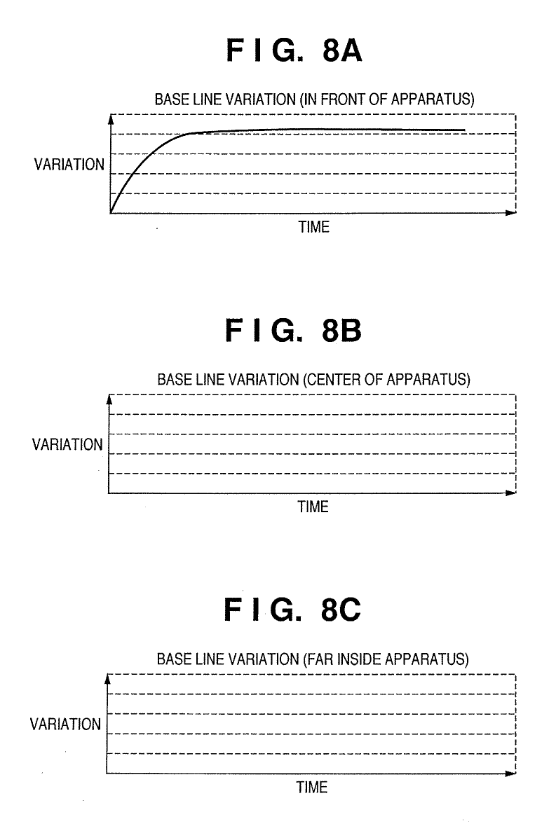

FIGS. 8A to 8C are graphs showing the relationship between the reticle stage position and the base line correction value. The ordinate of each graph represents the variation in base line. The abscissa represents the stop time of the reticle stage 4. FIG. 8A indicates a state wherein the reticle stage stops in front of the apparatus. FIG. 8B indicates a state wherein the reticle stage stops at the center of the apparatus. FIG. 8C indicates a state wherein the reticle stage stops far inside the apparatus. As shown in FIG. 8A, only when the reticle stage 4 stops in front of the apparatus, the base line correction value largely varies.

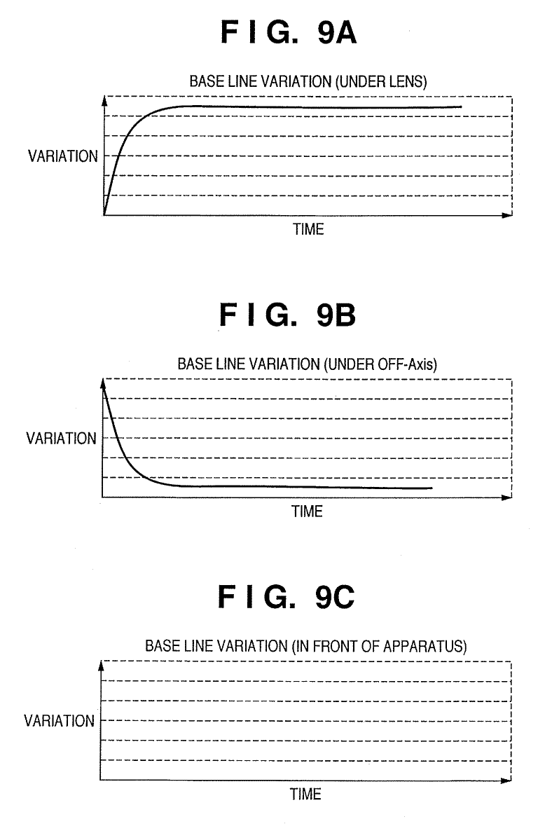

FIGS. 9A to 9C are graphs showing the relationship between the wafer stage position and the base line correction value. The ordinate of each graph represents the variation in base line. The abscissa represents the stop time of the wafer stage. FIG. 9A indicates a state wherein the wafer stage stops under the projection optical system lens. FIG. 9B indicates a state wherein the wafer stage stops under the Off-Axis observation optical system. FIG. 9C indicates a state wherein the wafer stage stops in front of the apparatus.

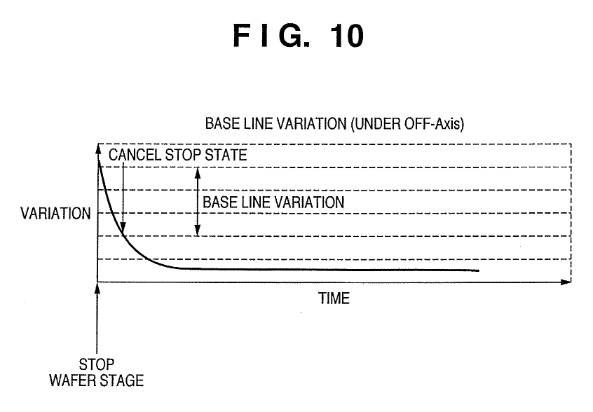

As shown in FIGS. 9A to 9C, when the wafer stage stops except in front of the apparatus, the base line correction value largely varies. In the apparatus, currently, the reticle stage 4 stops at the center of the apparatus, and the wafer stage stops under the Off-Axis observation optical system. The base line variation changes depending on the stop time of the wafer stage under the Off-Axis observation optical system. In this embodiment, if a time shown in FIG. 10 elapses from the wafer stage stop to cancel of the stop state, the base line should vary by about 6 nm during this time (one scale of the ordinate of FIG. 10 indicates 2 nm). If the threshold value of allowable base line variation is 5 nm, the determination unit 90 determines that “the base line correction value is invalid.”

Assume that the correction values (e.g., the focus correction value and the quadrature shifts of the reticle stage 4 and wafer stage from ideal grids) except the base line correction value with respect to the change in wafer stage temperature are valid. Hence, the exposure apparatus controller 70 re-measures the base line correction value immediately before the exposure process of the second wafer. Since the base line correction value changes, the exposure apparatus controller 70 automatically re-measures the already measured pre-alignment and alignment by reflecting the base line correction value.

Automatic re-measurement of pre-alignment is unnecessary because pre-alignment measurement is already complete only aiming at obtaining rough positions of alignment marks on the wafer for alignment measurement (absence of large positional shifts suffices). Automatic re-measurement of alignment is also unnecessary because the apparatus corrects the alignment measurement value (that reflects the base line correction value before re-measurement) after removing the alignment measurement error based on the difference between the base line correction value after re-measurement and that before re-measurement.

In this embodiment, the threshold value is set for a base line variation of 5 nm. The exposure apparatus may set the threshold value in advance. Alternatively, the memory (e.g., storage device 82) of the exposure apparatus may store the relationship between a unit state quantity and a correction value in the past, and the exposure apparatus controller 70 may automatically set the threshold value based on the relationship between a variation in unit state quantity and a variation in correction value. A host computer or the like may set the threshold value. It is preferable to prepare a “threshold value for a temperature change”, “threshold value for an atmospheric pressure change”, and “threshold value for a flow rate change” of a specific correction value of each unit. The validity of a correction value can be determined by employing the “most strict one” or “most lenient one” of the plurality of threshold values, or a “threshold value considering the process allowance.”

Since the allowable correction error changes depending on the process, a correction error may be set as a process parameter in advance. The host computer may set the process allowance. In this case, the exposure apparatus controller 70 decides the threshold value by determining the allowable range of correction error based on the process allowance.

In measurement such as base line measurement using a plurality of units, the correction value may be re-measured in the following way. Base line measurement uses the TTR observation optical system and Off-Axis observation optical system. In this case, the apparatus determines validity of the current state quantity of the TTR observation optical system and the current state quantity of the Off-Axis observation optical system. Re-measurement may be executed for only a unit whose state quantity is determined to be invalid.

### Fourth Embodiment

In a preferred fourth embodiment of the present invention, a control method of automatically recalculating correction values after the apparatus stops for a predetermined time will be described. FIG. 2 is a chart showing the sequence of an exposure process. The description of the sequence of the exposure process has been done above and will be omitted here.

A memory (e.g., storage device 82) stores unit state quantities (e.g., the temperature of a unit used in measurement, the internal and ambient atmospheric pressures of a unit used in measurement, and the flow rate of a liquid or gas used in a unit used in measurement) during correction/measurement together the correction values.

A determination unit 90 determines the validity of each correction value immediately before the exposure process. The correction values include not only the focus, base line, lens power, and alignment but also arbitrary correction values (e.g., scan shifts in scan-driving a reticle stage 4 and a wafer stage and quadrature shifts of the reticle stage 4 and wafer stage from ideal grids) to guarantee the performance of the exposure apparatus and arbitrary correction values (e.g., the magnification and deflection of a reticle 2 and the surface shape of a wafer 8) to accurately execute the exposure process. If the determination unit 90 determines that the correction values are valid, an exposure apparatus controller 70 executes the exposure process by correcting and driving the units by using the correction values. The criterion of the validity of each correction value and the determination method are the same as in the first embodiment, and a description thereof will be omitted.

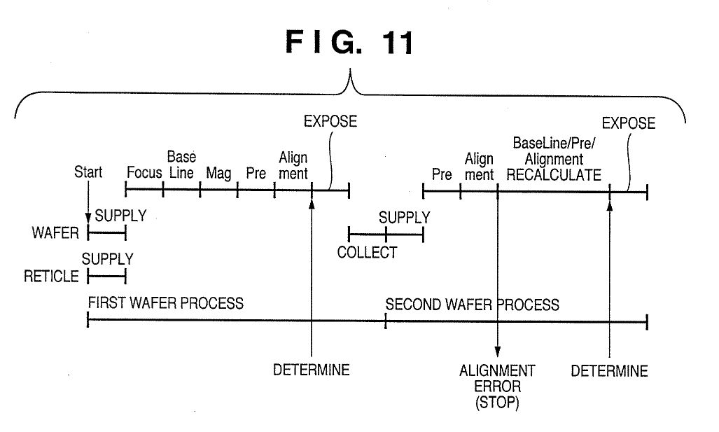

FIG. 11 is a chart showing the sequence of an exposure process in which a measurement error occurs during alignment measurement in the second wafer process of the exposure process sequence shown in FIG. 2, and the determination unit 90 executes correction value determination after the error stop of the apparatus and determines that the base line correction value is invalid so that the apparatus automatically executes base line measurement, pre-alignment, and alignment base line correction value recalculation.

Referring to FIG. 11, the focus, base line, lens power, and alignment measurements before the exposure process of the first wafer are normally complete. In addition, the determination unit 90 determines by correction value determination immediately before the exposure process for each wafer that the correction values are valid. For these reasons, the apparatus executes the exposure process of the first wafer by reflecting the correction values obtained by the correction value measurement immediately before, the correction values to guarantee the exposure apparatus performance, and the correction values for the accurate exposure process.

Assume that a measurement error has occurred during alignment measurement of the second wafer, and the apparatus has stopped by the error. As the positions of the target units (reticle stage 4 and wafer stage) of this example, the reticle stage 4 rests at the center of the apparatus, and the wafer stage rests under the Off-Axis observation optical system when the apparatus stops. With the stop of the apparatus, a timer function starts measuring the apparatus stop time.

FIGS. 8A to 8C are graphs showing the relationship between the reticle stage position and the base line correction value. FIGS. 9A to 9C are graphs showing the relationship between the wafer stage position and the base line correction value. A description of FIGS. 8A to 8C and 9A to 9C has been done above and will be omitted here. In the apparatus, currently, the reticle stage 4 stops at the center of the apparatus, and the wafer stage stops under the Off-Axis observation optical system. The base line variation changes depending on the stop time of the wafer stage under the Off-Axis observation optical system.

In this embodiment, if a time shown in FIG. 10 elapses from the wafer stage stop to cancel of the stop state, the base line should vary by about 6 nm during this time (one scale of the ordinate of FIG. 10 indicates 2 nm).

As is apparent from FIG. 10, when the wafer stage rests longer under the Off-Axis observation optical system, the base line correction value varies in the (−) direction. If the threshold value of allowable base line variation is 5 nm, the determination unit 90 determines that “the base line correction value is invalid.” Hence, the exposure apparatus controller 70 recalculates the base line correction value immediately before the exposure process of the second wafer. The exposure apparatus controller 70 recalculates the base line correction value by adding, to the current base line correction value, −6 nm that is expected as a variation during the stop of the wafer stage.

When the current base line correction value is 10 nm, the base line correction value is recalculated as current base line correction value (10 nm)+correction amount (−6 nm)=4 nm. The base line correction value to be reflected in the exposure process of the second wafer is 4 nm. As the correction value recalculation method, the apparatus may express the relationship between a correction value and a unit variation as a formula in advance and recalculate the correction value by substituting the unit variation to the formula.

In this embodiment, the relational expression between a current base line correction value (BL_{old}), a recalculated base line correction value (BL_{new}), and a wafer stage stop time (Δt) is given by
BL_{new}=BL_{old}/exp^{(Δt/k)} (3)
For example, when the time constant k is 10 sec, and the wafer stage stop time Δt is 9 sec, equation (3) is rewritten to BL_{new}=10/exp^{(9/10)}=4 [nm].

In this embodiment, the base line correction value is recalculated based on the relational expression between the base line correction value and the wafer stage stop time (including the stop position). However, obtaining the relational expression between a correction value and a unit state quantity in advance based on a theoretical value or an actual value on the apparatus makes it possible to recalculate each correction value based on a unit state quantity variation. In this embodiment, the relational expression between the base line correction value and the wafer stage stop time has been described. However, the correction value does not always vary in accordance with a change in only one unit state quantity.

Hence, the relational expression preferably contains changes in a plurality of unit state quantities. For accurate correction value recalculation, the relational expression of the base line correction value preferably reflects factors such as the above-described wafer stage temperature, projection optical system lens temperature, TTR observation optical system atmosphere temperature, and projection optical system lens atmospheric pressure that cause a variation in the correction value.

Since the base line correction value changes upon recalculation, the exposure apparatus controller 70 automatically recalculates the already measured pre-alignment and alignment by reflecting the base line correction value.

Automatic recalculation of pre-alignment is unnecessary because pre-alignment measurement is already complete only aiming at obtaining rough positions of alignment marks on the wafer for alignment measurement (absence of large positional shifts suffices).

The apparatus recalculates the alignment correction value from the already obtained alignment measurement value by uniformly offsetting the base line correction value variation (−6 nm, i.e., the difference between BL_{old} [10 nm] and BL_{new} [4 nm] in this example) to all the measurement values.

In this embodiment, the threshold value is set for a base line variation of 5 nm. The exposure apparatus may set the threshold value in advance. Alternatively, the memory (e.g., storage device 82) of the exposure apparatus may store the relationship between a unit state quantity and a correction value in the past, and the exposure apparatus controller 70 may automatically set the threshold value based on the relationship between a variation in unit state quantity and a variation in correction value. A host computer or the like may set the threshold value. It is preferable to prepare a “threshold value for a temperature change”, “threshold value for an atmospheric pressure change”, and “threshold value for a flow rate change” of a specific correction value of each unit. The validity of a correction value can be determined by employing the “most strict one” or “most lenient one” of the plurality of threshold values, or a “threshold value considering the process allowance.”

Since the allowable correction error changes depending on the process, a correction error may be set as a process parameter in advance. The host computer may set the process allowance. In this case, the exposure apparatus controller 70 decides the threshold value by determining the allowable range of correction error based on the process allowance.

In measurement such as base line measurement using a plurality of units, the correction value may be recalculated in the following way. Base line measurement uses the TTR observation optical system and Off-Axis observation optical system. In this case, the apparatus determines validity of the current state quantity of the TTR observation optical system and the current state quantity of the Off-Axis observation optical system. Recalculation may be executed for only a unit whose state quantity is determined to be invalid.

In the preferred first and second embodiments of the present invention, the validity of correction values is determined immediately before the exposure process. However, the apparatus may determine the validity of correction values at an arbitrary timing. Correction value validity determination at an arbitrary timing allows to maintain optimum exposure apparatus performance at an arbitrary timing.

As described above, according to the present invention, it is possible to accurately execute the exposure process by determining the validity of each correction value for the exposure process of the exposure apparatus. Preparing a plurality of criteria for each correction value enables re-measurement or recalculation at minimum necessary timings. Hence, the exposure apparatus can operate efficiently.

### APPLICATION EXAMPLE

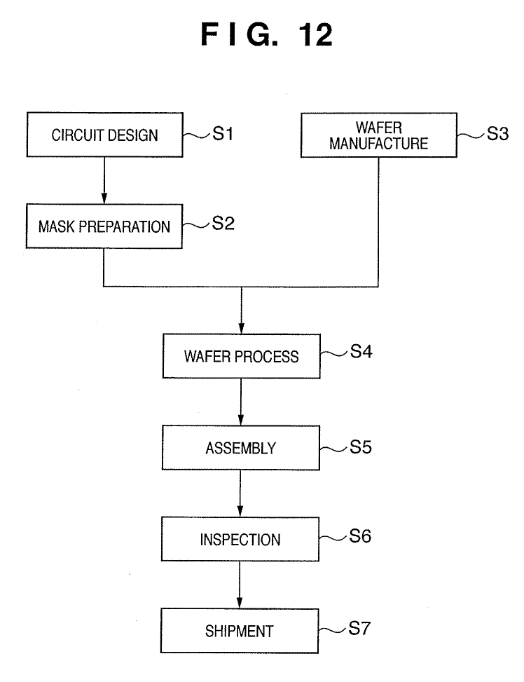

A semiconductor device manufacturing process using the above-described exposure apparatus will be described next. FIG. 12 is a flowchart showing the entire semiconductor device manufacturing process. In step 1 (circuit design), the semiconductor device circuit is designed. In step 2 (mask preparation), a mask (also called a master or reticle) is prepared based on the designed circuit pattern. In step 3 (wafer manufacture), a wafer (also called a substrate) is manufactured using a material such as silicon. In step 4 (wafer process) called a preprocess, the exposure apparatus forms an actual circuit on the wafer by lithography using the mask and wafer. In step 5 (assembly) called a post-process, a semiconductor chip is formed from the wafer prepared in step 4. This step includes assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

The wafer process in step 4 includes the oxidation step of oxidizing the wafer surface, the CVD step of forming an insulating film on the wafer surface, the electrode formation step of forming an electrode on the wafer by deposition, the ion implantation step of implanting ions into the wafer, the resist process step of applying a resist to the wafer, the exposure step of causing the exposure apparatus to expose the wafer after the resist process step through the mask with the pattern to form a latent image pattern on the resist, the development step of developing the latent image pattern of the wafer exposed in the exposure step, the etching step of etching portions other than the resist image developed in the development step, and the resist removal step of removing any unnecessary resist remaining after etching. By repeating these steps, the exposure apparatus forms multiple circuit patterns on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-295557 filed on Oct. 7, 2005, which is hereby incorporated by reference herein in its entirety.

What is claimed is:

1. An exposure apparatus for exposing a substrate to a pattern, the apparatus comprising:
a unit; and
a controller configured to determine, based on a state quantity of the unit upon executing one of calibration of the unit and measurement by the unit and a current state quantity of the unit, whether one of the calibration and the measurement is valid, and to control, upon determining that one of the calibration and the measurement is invalid, an operation of the exposure apparatus so that said one of the calibration and the measurement is re-executed.

2. The apparatus according to claim 1, wherein the controller is configured to determine that one of the calibration and the measurement is valid when an absolute value of a difference between the state quantity of the unit upon executing one of the calibration and the measurement and the current state quantity of the unit is not more than a threshold, and determine that one of the calibration and the measurement is invalid when the absolute value is more than the threshold.

3. The apparatus according to claim 1, wherein the controller is configured to validate an offset value set for the unit based on one of the calibration and the measurement upon determining that one of the calibration and the measurement is valid.

4. The apparatus according to claim 2, wherein
the controller is configured to calculate an offset value for the unit based on one of the calibration and the measurement, and to recalculate, upon determining that one of the calibration and the measurement is invalid, the offset value based on a relationship between the offset value and the state quantity.

5. The apparatus according to claim 1, wherein the unit includes at least one of a focus measurement unit, an alignment measurement unit, a projection optical system for projecting light from a reticle to the substrate, a reticle stage, and a substrate stage.

6. The apparatus according to claim 1, wherein the state quantity is related to at least one of a temperature, an atmospheric pressure, a flow rate of a coolant, a position, and a stop time.

7. A method applied to an exposure apparatus for exposing a substrate to a pattern, the method comprising steps of:
determining, based on a state quantity of a unit upon executing one of calibration of the unit and measurement by the unit and a current state quantity of the unit, whether one of the calibration and the measurement is valid; and
controlling, if it is determined that one of the calibration and the measurement is invalid, an operation of the exposure apparatus so that said one of the calibration and the measurement is re-executed.

8. The method according to claim 7, wherein the determining step determines that one of the calibration and the measurement is valid when an absolute value of a difference between the state quantity of the unit upon executing one of the calibration and the measurement and the current state quantity of the unit is not more than a threshold, and the determining step determines that one of the calibration and the measurement is invalid when the absolute value is more than the threshold.

9. The method according to claim 7, wherein when the determining step determines that one of the calibration and the measurement is valid, an offset value set for the unit based on one of the calibration and the measurement is validated.

10. The method according to claim 7, further comprising a step of calculating an offset value for the unit based on one of the calibration and the measurement,
wherein if it is determined that one of the calibration and the measurement is invalid, the controlling step recalculates the offset value based on a relationship between the offset value and the state quantity.

11. The method according to claim 7, wherein the unit includes at least one of a focus measurement unit, an alignment measurement unit, a projection optical system for projecting light from a reticle to the substrate, a reticle stage, and a substrate stage.

12. The method according to claim 7, wherein the state quantity is related to at least one of a temperature, an atmospheric pressure, a flow rate of a coolant, a position, and a stop time.

13. A method of manufacturing a device, said method comprising steps of:
exposing a substrate to a pattern using an exposure apparatus as defined claim 1;
developing the exposed substrate; and
processing the developed substrate to manufacture the device.
